(19) United States
(12) Patent Application Publication
(10) Pub. No.: US 2026/0212653 A1
(43) Pub. Date: Jul. 23, 2026

(54) METHOD, APPARATUS, DEVICE AND STORAGE MEDIUM FOR INFORMATION PROCESSING

(71) Applicants: Beijing Zitiao Network Technology Co., Ltd., Beijing (CN); Bytedance Technology Ltd., Grand Cayman (KY)

(72) Inventors: Yujia QIN, Beijing (CN); Haoming WANG, Beijing (CN); Junjie FANG, Beijing (CN); Yining YE, Beijing (CN); Shihao LIANG, Beijing (CN); Shizuo TIAN, Beijing (CN); Junda ZHANG, Singapore (SG); Jiahao LI, Beijing (CN); Qianli MA, Beijing (CN); Longxiang LIU, Beijing (CN); Yunxin LI, Beijing (CN); Shijue HUANG, Beijing (CN); Wanjun ZHONG, Beijing (CN)

(21) Appl. No.: 19/451,931

(22) Filed: Jan. 16, 2026

(30) Foreign Application Priority Data
Jan. 20, 2025 (CN) 202510089471.2

(51) Int. Cl. G06V 10/774; G06F 3/0484; G06V 10/764; G06V 10/776

(52) U.S. Cl. CPC G06V 10/774; G06F 3/0484; G06V 10/764; G06V 10/776

(57) ABSTRACT

Embodiments of the disclosure relate to a method, an apparatus, a device and a computer readable storage medium for information processing. The method provided by the disclosure includes: generating, in response to receiving an input message, a first instruction associated with a target interface with a model and based on the input message and the first image of the target interface; triggering execution of the first instruction in the target interface to determine a second image of the target interface; generating at least one subsequent instruction associated with the target interface with the model and based on the second image and the input message; and triggering execution of at least one subsequent instruction in the target interface.

### CROSS-REFERENCE

The present application claims priority to Chinese Patent Application No. 202510089471.2, filed on Jan. 20, 2025 and entitled “METHOD, APPARATUS, DEVICE AND STORAGE MEDIUM FOR INFORMATION PROCESSING”, the disclosures of which are incorporated herein by reference in their entireties.

### FIELD

Example embodiments of the present disclosure generally relate to the field of computers, and in particular, to a method, an apparatus, a device, and a computer-readable storage medium for information processing.

### BACKGROUND

RPA (Robotic Process Automation) is a technology that simulates human operation by software robots or automated tools to achieve repetitive task automation. RPA can reduce manual intervention, improve work efficiency and accuracy, and is especially suitable for business processes with clear rules and strong repeatability.

### SUMMARY

In a first aspect of the present disclosure, a method for information processing is provided. The method includes: generating, in response to receiving an input message, a first instruction associated with a target interface with a model and based on the input message and the first image of the target interface; triggering execution of the first instruction in the target interface to determine a second image of the target interface; generating at least one subsequent instruction associated with the target interface with the model and based on the second image and the input message; and triggering execution of at least one subsequent instruction in the target interface.

In a second aspect of the present disclosure, an apparatus for information processing is provided. The apparatus includes: a first generating module configured to generate, in response to receiving an input message, a first instruction associated with a target interface with a model and based on the input message and a first image of the target interface; a first triggering module configured to trigger execution of the first instruction in the target interface to determine a second image of the target interface; a second generating module configured to generate at least one subsequent instruction associated with the target interface with the model and based on the second image and the input message; and a second triggering module configured to trigger execution of the at least one subsequent instruction in the target interface.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this section is not intended to define the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent when taken in conjunction with the accompanying drawings and with reference to the following detailed description. In the drawings, the same or similar reference numbers refer to the same or similar elements, wherein:

FIG. 1 illustrates a schematic diagram of an example environment in which embodiments according to the present disclosure may be implemented;

FIG. 2 shows a flowchart of an example process for information processing according to some embodiments of the present disclosure;

FIG. 3 illustrates an architecture diagram of an example model for information processing according to some embodiments of the present disclosure;

FIG. 4 illustrates a schematic structural block diagram of an example apparatus for information processing according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related provisions. In the embodiments of the present disclosure, all of data collection, acquisition, handling, processing, forwarding, use, etc. are performed on the premise that the user knows and confirms s. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

Traditional RPA is implemented by rules that have significant drawbacks when faced with complex, dynamic, and unstructured task. For example, traditional RPA is to perform task based on rules, lacking intelligent decision capability. They cannot handle complex, unstructured data, nor do reasoning and learning.

The embodiments of the disclosure provide an information processing scheme. The scheme includes: generating, in response to receiving an input message, a first instruction associated with a target interface with a model and based on the input message and the first image of the target interface; triggering execution of the first instruction in the target interface to determine a second image of the target interface; generating at least one subsequent instruction associated with the target interface with the model and based on the second image and the input message; and triggering execution of at least one subsequent instruction in the target interface.

In this way, embodiments of the present disclosure can understand and execute tasks by using pure visual perception, do not need to rely on API calls or predefined rules, thereby having stronger generalization ability and adaptability, and can handle more complex and dynamic interface interaction task.

Various example implementations of this scheme are described in detail below in conjunction with the accompanying drawings.

### Example Environment

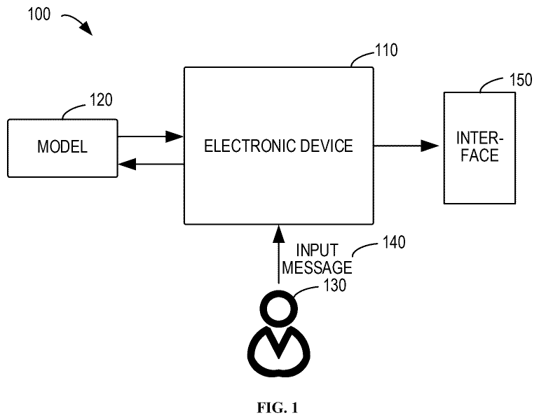

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may present an interface 150 to the user 130. As an example, such an interface 150 may include a graphical user interface of the electronic device 110.

As will be described in detail below, the electronic device 110 may obtain an input message 140 of the user 130 and may utilize model 120 to generate a set of instructions based on the image of the interface 150 to complete the task indicated by the input message 140.

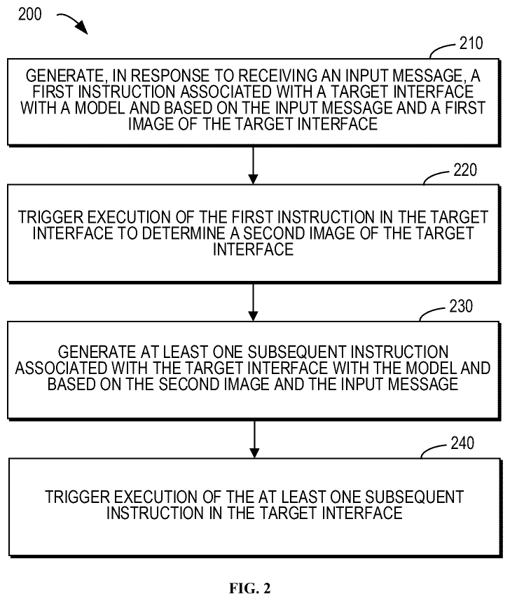

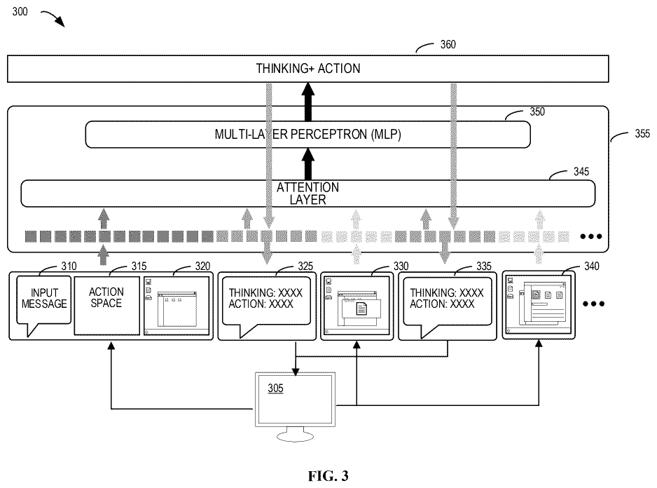

A detailed process for generating the set of instructions with model 120 will be described in detail below with reference to FIGS. 2 and 3.

The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Processes

FIG. 2 shows a flowchart of an example process 200 for information processing according to some embodiments of the present disclosure. Process 200 may be implemented at electronic device 110.

As shown, at block 210, the electronic device 110 generates, in response to receiving the input message, a first instruction associated with the target interface with the model and based on the input message and the first image of the target interface.

An example architecture of model 120 will be described below with reference to FIG. 3. As shown in FIG. 3, the electronic device 110 may obtain an input message 310 of the user. As an example, the input message 310 of the user may include, for example, a text message or a voice message.

Further, the electronic device 110 may provide the input message 310 and the first image 320 of the target interface 305 to the model 355. Additionally, the electronic device 110 may also provide an action space 315 (also referred to as action description information) to model 355, which may indicate a candidate action set associated with the target interface 305.

As an example, the description information of the candidate action set may refer to Table 1.

TABLE 1
Action Space Definition

| environment | action | definition |
|---|---|---|
| independence of platform | click action | click a specified location (x, y) |
| | dragging action | dragging from (x1, y1) to(x2, y2) |
| | scrolling action | Scrolling in a specified direction |
| | | a (x, y) |
| | typing action | typing a specified content |
| | waiting action | waiting for a predetermined |
| | | duration |
| | completion action | marking a task as being |
| | | completed |
| | call action | requesting user intervention |
| desktop environment | hotkey action | press a specified hotkey |
| | left-double-click action | left-double-click (x, y) |
| | right-click action | right-click (x, y) |
| mobile environment | long press action | long press a specified location |
| | | (x, y) |
| | pressing action for a return button | click on the return button |
| | pressing action for a home button | click on a home button |
| | pressing action for a enter key | click on a enter key |

By defining the action space 315, model 355 can determine a current action to be performed from the action space 315 based on the input message 310 and the first image 320 of the target interface 305.

As shown in FIG. 3, the model 355 may generate output information 325 based on the input message 310, the action space 315, and the first image 320, and the output information 325 may include thinking information about determining a target action to be performed (also referred to as inference information) and the target action to be performed.

As an example, the model 355 may be configured to first generate inference information on how to select an action, which may describe a reason for selecting the target action from the action space. Further, model 355 may further output the selected target action.

In some embodiments, the model 355 may be implemented, for example, based on a visual language model, which may include, for example, a plurality of attention layers 345 and a multi-layer perceptron 350. As an example, the model 355 may obtain a first set of text features corresponding to the input message 310, a second set of text features corresponding to the action space 315, and an image feature corresponding to the first image 320, so as to generate the output feature 360. The output feature 360 may be converted to output information 325, i.e., text content for describing the inference information and the target action.

At block 220, the electronic device 110 triggers execution of the first instruction in the target interface to determine a second image of the target interface.

Further, the electronic device 110 may utilize the interface automation tool to specify a first instruction corresponding to the generated target action. As an example, the first instruction may instruct the electronic device 110 to click a specified location in the target interface 305.

In some embodiments, after the predetermined duration of completion of the first instruction's excution, the electronic device 110 may obtain the second image 330 of the target interface 305.

At block 230, the electronic device 110 generates at least one subsequent instruction associated with the target interface with the model and based on the second image and the input message.

With continued reference to FIG. 3, the electronic device 110 may update the input feature sequence of the model 355 based on the output information 325 and the second image 330, thereby generating output information 335 corresponding to the second image 330. The output information 335 may include inference information about how the action to be performed is selected under the observation of the second image 330, and the determined action.

At block 240, the electronic device 110 triggers execution of at least one subsequent instruction in the target interface.

Further, the electronic device 110 may iteratively execute the instruction corresponding to the determined action in the target interface 305, and may obtain an updated image, for example, the image 340, after the instruction is completed. Such updated images may be further provided as new observation information to generate new inference information and action information.

Thus, the process of model 355 may be expressed as:

$$P ( {t}_{n} , {a}_{n} \vert instruction , {o}_{1} , {t}_{1} , {a}_{1} , … , {( {o}_{n - i} , {t}_{n - i} , {a}_{n - i} )}_{i = 1}^{5} , {o}_{n} ) \qquad ( 1 )$$

where the instruction represents the input information of the user, oₖ represents the kth image of the target interface, tₖ represents the inference information generated based on the kth image, and aₖ represents the action information generated based on the kth image.

Based on the formula (1), it can be seen that when generating the inference information and the action information corresponding to the n-th image, the electronic device may obtain the input sequence corresponding to the n-th image (also referred to as the third image). Specifically, the input sequence may include a set of historical instructions constructed based on an input message and a set of inference information corresponding to the set of historical instructions. For example, the input sequence may include all historical instructions (i.e., historical actions a₁ to αₙ₋₁) corresponding to the first image to the (n−1)-th image and corresponding thinking information t₁ to tₙ₋₁.

In addition, in order to reduce the transmission cost of the context information, the number of the historical images reserved by the set of input sequences may be less than or equal to a predetermined number. Taking equation (1) as an example, the input sequence may, for example, reserve up to 5 historical images, e.g., oₙ₋₅ to oₙ₋₁.

In this way, embodiments of the present disclosure can understand and perform tasks by using pure visual perception, do not need to rely on API calls or predefined rules, thereby having stronger generalization ability and adaptability, and can handle more complex and dynamic interface interaction task.

The training process of the model mentioned above will be further described below.

In some embodiments, to improve the perception capability of the model on the interface, the model may be trained based on one or more of the following task: a first training task configured to generate an answer to a question associated with the interface image, a second training task configured to generate a description for a set of elements in the interface image, a third training task configured to generate a description for an element marked in the interface image, a fourth training task configured to generate an image description text for the interface image; and a fifth training task configured to generate a difference description for two interface images.

As an example, the first training task may be associated with a first sample data, and the first sample data may include the question “what is the application like a waveform in the interface?” and a corresponding annotation answer.

As an example, the second training task may be associated with a second sample data, the second sample data may include query item “please describe all elements in the interface” and corresponding annotation content, and the annotation content may describe elements at various locations in the interface.

As an example, the third training task may be associated with a third sample data, and the third sample data may include the query item “what is the element content in the yellow block in the interface?” and a corresponding annotation answer “it is a button containing words ‘xxx’”.

As an example, the fourth training task may be associated with a fourth sample data, and the fourth sample data may include detailed description text for the interface screen.

As an example, the fifth training task may be associated with a fifth sample data, and the fifth sample data may include description text about the difference content of the images of the interface at the two moments.

In some embodiments, the at least one training task may be performed based on a set of training interface images and corresponding reference description information. In some embodiments, such reference description information may indicate a type of interface element in a set of training interface images. For example, the elements in the interface may be classified into a plurality of predetermined types, including but not limited to: a button, a text area, a scroll bar, and the like.

Alternatively or additionally, the reference description information may indicate an appearance description of the interface elements in the set of training interface images. For example, such an appearance description may include the shape, color, style, etc. of the element.

Alternatively or additionally, the reference description information may indicate location information of interface elements in the set of training interface images. For example, such location information may describe spatial locations of the element relative to other elements.

Alternatively or additionally, the reference description information may indicate a function description of an interface element in the set of training interface images. For example, such function description information may indicate the function and interaction manner of the elements.

In some embodiments, the model is also trained based on the training dataset. Specifically, the training dataset may be constructed based on: determining, with a classifier, a first set of candidate samples from a candidate sample set, a candidate sample in the candidate sample set indicating an action flow in the interface; providing the first set of candidate samples to a language model to determine a second set of candidate samples; performing a deduplication processing on the second set of candidate samples to determine a third set of candidate samples; and adjusting, with a language model, a text description of the third set of candidate samples to construct the training dataset.

For example, the text classifier may be used to classify the candidate samples in the candidate sample set to reserve the first set of candidate samples whose quality meets the condition. Further, one or more samples whose quality does not meet the condition may be further filtered out from the first set of candidate samples by using the language model, to obtain the second set of candidate samples.

Additionally, multiple samples in the second set of candidate samples may be deduplicated. For example, deduplication processing may be performed based on resource locators and locity-sensitive hashing (LSH). Further, the text expression of the deduplicated sample may be optimized with a language model.

In some embodiments, to improve the inference capability of the model, the training dataset may further include annotation information associated with a set of predetermined inference modes.

In some embodiments, the training dataset may include annotation information associated with a first inference mode. The first inference mode may also be referred to as a key knowledge recall, to instruct the model to obtain the key knowledge information related to the task.

In some embodiments, the training dataset may include annotation information associated with a second inference mode. The second inference mode may also be referred to as long-term consistency, to indicate the model to refer to the operation history of task.

In some embodiments, the training dataset may include annotation information associated with a third inference mode. The third inference mode may also be referred to as task decomposition, which may instruct the model to decompose the task into multiple sub-tasks and identify the completion of the milestone node.

In some embodiments, the training dataset may include annotation information associated with a fourth inference mode. The fourth inference mode may also be referred to as a trial and error, which may instruct the model to generate an attempt action and evaluate the attempt results, and may be applied to the processing of some fuzzy scenarios.

In some embodiments, the training dataset may include annotation information associated with a fifth inference mode. The fifth inference mode may also be referred to as error refinement, which may instruct the model to identify errors in the task processing process and correct errors.

In some embodiments, in order to enrich the training samples, new samples may also be constructed based on resampling techniques. Specifically, the input message may be processed using a preliminary trained model to indicate an action that generates an error. Accordingly, the sequence of actions before the error action may remain as new sample data.

In addition, for a running model, electronic device 110 may perform quality evaluation on the instruction sequence generated by the model, and may reserve an instruction sequence whose quality is better than the threshold to fine tune the model. As an example, the reserved instruction sequence may be determined based on rule filtering, personnel labeling, or model scoring.

In addition, if the instruction sequence of the input message includes an error instruction, a first negative sample may be constructed based on the instruction sequence, and the first negative sample ends at the error instruction. Further, the first positive sample may be constructed by correcting the error instruction. Additionally, the model may be fine-tuned based on the first negative sample and the first positive sample.

As an example, the first negative sample and the first positive sample may be expressed as:

$${T}^{-} = instruction , ( {o}_{1} , {t}_{1} , {a}_{1} ) , ( {o}_{2} , {t}_{2} , {a}_{2} ) , … , ( {o}_{r} , {t}_{r} , {a}_{r} ) \qquad ( 2 )$$

$${T}^{+} = instruction , ( {o}_{1} , {t}_{1} , {a}_{1} ) , ( {o}_{2} , {t}_{2} , {a}_{2} ) , … , ( {o}_{r} , {t}_{r}^{*} , {a}_{r}^{*} )$$

where, t_{τ}, a_{T} represents incorrect thinking and action, and

$${t}_{r}^{*} , {a}_{r}^{*}$$

represents the corrected thinking and action.

In some embodiments, a second negative sample corresponding to the instruction sequence may also be constructed, where the second negative sample includes an error instruction, and a reference subsequent instruction of the error instruction in the instruction sequence, and a second positive sample may be generated by reserving the error instruction and correcting the reference subsequent instruction. Further, the model may be fine-tuned based on the second negative sample and the second positive sample.

As an example, the second negative sample and the second positive sample may be expressed as:

$${T}^{-} = instruction , ( {o}_{1} , {t}_{1} , {a}_{1} ) , ( {o}_{2} , {t}_{2} , {a}_{2} ) , … , ( {o}_{r} , {t}_{r} , {a}_{r} ) , ( {o}_{r + 1} , {t}_{r + 1} , {a}_{r + 1} ) \qquad ( 3 )$$

$${T}^{+} = instruction , ( {o}_{1} , {t}_{1} , {a}_{1} ) , ( {o}_{2} , {t}_{2} , {a}_{2} ) , … , ( {o}_{r} , {t}_{r} , {a}_{r} ) , ( {o}_{r + 1} , {t}_{r + 1}^{*} , {a}_{r + 1}^{*} )$$

where t_{τ}, a_{τ} represents an incorrect thinking and action, t_{τ+1}, a_{τ+1} represents a next thinking and action generated by the model, and

$${t}_{r + 1}^{*} , {a}_{r + 1}^{*}$$

represents the labeling thinking and action for correcting the error.

In this way, embodiments of the present disclosure may further provide error correction capabilities of the model.

Additionally, the model may further adjust an output result of the model based on direct preference optimization (DPO), thereby improving output quality of the model.

### Example Apparatus and Device

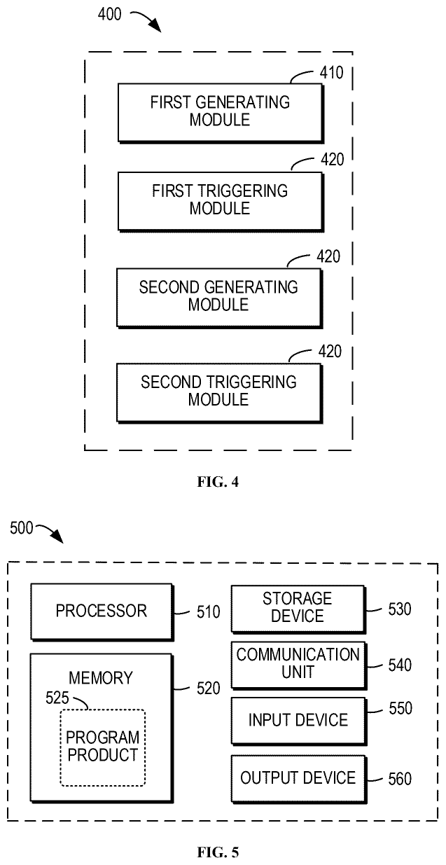

Embodiments of the present disclosure also provide a corresponding apparatus for implementing the above method or process. FIG. 4 shows a schematic structural block diagram of an example apparatus 400 for information processing according to some embodiments of the present disclosure. The apparatus 400 may be implemented or included in the electronic device 110 or the system 300. The various modules/components in the apparatus 400 may be implemented by hardware, software, firmware, or any combination thereof.

As shown in FIG. 4, the apparatus 400 includes: a first generating module 410 configured to generate, in response to receiving an input message, a first instruction associated with a target interface with a model and based on the input message and the first image of the target interface; a first triggering module 420 configured to trigger execution of the first instruction in the target interface to determine a second image of the target interface; a second generating module 430 configured to generate at least one subsequent instruction associated with the target interface with the model and based on the second image and the input message; and a second triggering module 440 configured to trigger execution of the at least one subsequent instruction in the target interface.

In some embodiments, the first generating module 410 is further configured to: provide the input message, the first image, and action description information to the model, where the action description information indicates a candidate action set associated with the target interface; and obtain the first instruction generated by the model, where the first instruction corresponds to a target action in the candidate action set.

In some embodiments, the set action set includes a plurality of: a click action for the specified position, a dragging action associated with the start position and the end position, a scrolling action associated with the specified direction, a typing action associated with the specified content, awaiting action of waiting for a predetermined duration, a call action for requesting user intervention, and a completion action marking a task corresponding to the input message as being completed.

In some embodiments, the model is further configured to: generate, before generating the first instruction, inference information associated with the first instruction, the inference information indicating a reason for selecting the target action from the candidate action set.

In some embodiments, the at least one subsequent instruction is further generated based on the inference information associated with the first instruction.

In some embodiments, the at least one subsequent instruction includes a third instruction, and the second generating module 430 is further configured to: obtain a third image associated with the target interface; construct an input sequence associated with the third image, the input sequence including a set of historical instructions, a set of inference information and a set of historical images associated with the set of historical instructions, where the number of the set of historical images is less than or equal to a preset number; and provide the input sequence to the model to generate the third instruction.

In some embodiments, the apparatus 400 further includes an obtaining module configured to obtain the second image of the target interface after a predetermined duration of completion of the first instruction's excution.

In some embodiments, the model is trained based on at least one of the following training tasks: a first training task configured to generate an answer to a question associated with the interface image, a second training task configured to generate a description for a set of elements in the interface image, a third training task configured to generate a description for an element marked in the interface image; a fourth training task configured to generate an image description text for the interface image; a fifth training task configured to generate a difference description for the two interface images.

In some embodiments, the at least one training task is based on a set of training interface images and reference description information corresponding to the set of training interfaces, and the reference description information indicates at least one of: a type of an interface element in the set of training interface images; an appearance description of interface elements in the set of training interface images; location information of an interface element in the set of training interface images; a function description of an interface element in the set of training interface images.

In some embodiments, the model is further trained based on a training dataset constructed based on: determining, with a classifier, a first set of candidate samples from a candidate sample set, where a candidate sample in the candidate sample set indicates an action flow in the interface; providing the first set of candidate samples to the language model to determine a second set of candidate samples; performing a deduplication processing on the second set of candidate samples to determine a third set of candidate samples; and adjusting, with a language model, text descriptions of the third set of candidate samples to construct the training dataset.

In some embodiments, the training dataset includes annotation information associated with a set of predetermined inference modes, and the set of predetermined inference modes includes at least one of: a first inference mode indicating that the model obtains knowledge information related to a task, a second inference mode indicating that the model refers to an operation history of a task, a third inference mode indicating that the model decomposes a task into a plurality of sub-tasks, a fourth reasoning mode indicating that the model generates an attempt action and evaluating an attempt result, a fifth reasoning mode indicating that the model identifies an error in a task processing process and correcting the error.

In some embodiments, the apparatus 400 further includes a first adjustment module configured to construct, in response to an instruction sequence for the input message including an error instruction, a first negative sample based on the instruction sequence, the first negative sample ending at the error instruction; construct a first positive sample by correcting the error instruction; and fine-tune the model based on the first negative sample and the first positive sample.

In some embodiments, the apparatus 400 further includes a second adjustment module configured to construct a second negative sample corresponding to the instruction sequence, the second negative sample including the error instruction and a reference subsequent instruction of the error instruction in the instruction sequence; generate a second positive sample by reserving the error instruction and correcting the reference subsequent instruction; and fine-tune the model based on the second negative sample and the second positive sample.

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the electronic device 110 of FIG. 1 or the system 300 of FIG. 3.

As shown in FIG. 5, the electronic device 500 is in the form of a general-purpose electronic device. Components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may include additional removable/non-removable, volatile/non-volatile storage media. Although not shown in FIG. 5, a disk drive for reading to or writing from a removable, nonvolatile magnetic disk (e.g., a “floppy disk”) and an optical disk drive for reading to or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

Communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions marked in the blocks may also occur in a different order than marked in the drawings. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for information processing, comprising:
generating, in response to receiving an input message, a first instruction associated with a target interface with a model and based on the input message and a first image of the target interface;
triggering execution of the first instruction in the target interface to determine a second image of the target interface;
generating at least one subsequent instruction associated with the target interface with the model and based on the second image and the input message; and
triggering execution of the at least one subsequent instruction in the target interface.

2. The method of claim 1, wherein generating the first instruction associated with the target interface with the model and based on the input message and the first image of the target interface comprises:
providing the input message, the first image, and action description information to the model, the action description information indicating a candidate action set associated with the target interface; and
obtaining the first instruction generated by the model, the first instruction corresponding to a target action in the candidate action set.

3. The method of claim 2, wherein the action set comprises a plurality of:
a click action for a specified location,
a dragging action associated with the start and end positions,
a scrolling action associated with a specified direction,
a typing action associated with a specified content,
a waiting action of waiting for a predetermined duration,
a call action requesting user intervention,
a completion action marking a task corresponding to the input message as being completed.

4. The method of claim 2, wherein the model is further configured to:
generate, before generating the first instruction, inference information associated with the first instruction, the inference information indicating a reason for selecting the target action from the candidate action set.

5. The method of claim 4, wherein the at least one subsequent instruction is further generated based on the inference information associated with the first instruction.

6. The method of claim 4, wherein the at least one subsequent instruction comprises a third instruction, and generating, with the model, the third instruction associated with the target interface comprises:
obtaining a third image associated with the target interface;
constructing an input sequence associated with the third image, the input sequence comprising a set of historical instructions, a set of inference information and a set of historical images associated with the set of historical instructions, wherein a number of the set of historical images is less than or equal to a predetermined number; and
providing the input sequence to the model to generate the third instruction.

7. The method of claim 1, further comprising:
obtaining the second image of the target interface after a predetermined duration of completion of the first instruction's excution.

8. The method of claim 1, wherein the model is trained based on at least one of the following training tasks:
a first training task configured to generate an answer to a question associated with the interface image,
a second training task configured to generate a description for a set of elements in the interface image,
a third training task configured to generate a description for an element marked in the interface image,
a fourth training task configured to generate an image description text for the interface image,
a fifth training task configured to generate a difference description for two interface images.

9. The method of claim 8, wherein the at least one training task is based on a set of training interface images and reference description information corresponding to the set of training interfaces images, and the reference description information indicates at least one of:
a type of an interface element in the set of training interface images,
an appearance description of an interface element in the set of training interface images,
position information of an interface element in the set of training interface images,
a function description of an interface element in the set of training interface images.

10. The method of claim 1, wherein the model is further trained based on a training dataset constructed based on:
determining, with a classifier, a first set of candidate samples from a candidate sample set, wherein a candidate sample in the candidate sample set indicates an action flow in the interface;
providing the first set of candidate samples to a language model to determine a second set of candidate samples;
performing a deduplication processing on the second set of candidate samples to determine a third set of candidate samples; and
adjusting, with a language model, text descriptions of the third set of candidate samples to construct the training dataset.

11. The method of claim 10, wherein the training dataset comprises annotation information associated with a set of predetermined inference modes, and the set of predetermined inference modes comprises at least one of:
a first inference mode indicating that the model obtains knowledge information related to a task,
a second inference mode indicating that the model refers to an operation history of a task,
a third inference mode indicating that the model decomposes a task into a plurality of sub-tasks,
a fourth inference mode indicating that the model generates an attempt action and evaluates an attempt result,
a fifth inference mode indicating that the model identifies an error in a task processing process and corrects the error.

12. The method of claim 1, further comprising:
constructing, in response to an instruction sequence for the input message comprising an error instruction, a first negative sample based on the instruction sequence, the first negative sample ending at the error instruction;
constructing a first positive sample by correcting the error instruction; and
fine-tuning the model based on the first negative sample and the first positive sample.

13. The method of claim 12, further comprising:
constructing a second negative sample corresponding to the instruction sequence, the second negative sample comprising the error instruction and a reference subsequent instruction of the error instruction in the instruction sequence;
generating a second positive sample by reserving the error instruction and correcting the reference subsequent instruction; and
fine-tuning the model based on the second negative sample and the second positive sample.

14. An electronic device, comprising:
at least one processor; and
at least one memory coupled to the at least one processor and storing instructions for execution by the at least one processor, the instructions, when executed by the at least one processor, causing the electronic device to performacts comprising:
generating, in response to receiving an input message, a first instruction associated with a target interface with a model and based on the input message and a first image of the target interface;
triggering execution of the first instruction in the target interface to determine a second image of the target interface;
generating at least one subsequent instruction associated with the target interface with the model and based on the second image and the input message; and
triggering execution of the at least one subsequent instruction in the target interface.

15. The electronic device of claim 14, wherein generating the first instruction associated with the target interface with the model and based on the input message and the first image of the target interface comprises:
providing the input message, the first image, and action description information to the model, the action description information indicating a candidate action set associated with the target interface; and
obtaining the first instruction generated by the model, the first instruction corresponding to a target action in the candidate action set.

16. The electronic device of claim 15, wherein the action set comprises a plurality of:
a click action for a specified location,
a dragging action associated with the start and end positions,
a scrolling action associated with a specified direction,
a typing action associated with a specified content,
a waiting action of waiting for a predetermined duration,
a call action requesting user intervention,
a completion action marking a task corresponding to the input message as being completed.

17. The electronic device of claim 15, wherein the model is further configured to:
generate, before generating the first instruction, inference information associated with the first instruction, the inference information indicating a reason for selecting the target action from the candidate action set.

18. The electronic device of claim 17, wherein the at least one subsequent instruction is further generated based on the inference information associated with the first instruction.

19. The electronic device of claim 17, wherein the at least one subsequent instruction comprises a third instruction, and generating, with the model, the third instruction associated with the target interface comprises:
obtaining a third image associated with the target interface;
constructing an input sequence associated with the third image, the input sequence comprising a set of historical instructions, a set of inference information and a set of historical images associated with the set of historical instructions, wherein a number of the set of historical images is less than or equal to a predetermined number; and
providing the input sequence to the model to generate the third instruction.

20. A computer program product tangibly embodied on a non-transitory computer-readable storage medium and comprising instructions that, when executed by at least one computing device, are configured to cause the at least one computing device to perform operations comprising:
generating, in response to receiving an input message, a first instruction associated with a target interface with a model and based on the input message and a first image of the target interface;
triggering execution of the first instruction in the target interface to determine a second image of the target interface;
generating at least one subsequent instruction associated with the target interface with the model and based on the second image and the input message; and
triggering execution of the at least one subsequent instruction in the target interface.
